(19) United States
(12) Patent Application Publication
(10) Pub. No.: US 2026/0366520 A1
(43) Pub. Date: Nov. 19, 2026

(54) Impeller for a Pump and a Pump Comprising Such an Impeller

(71) Applicant: Xylem Europe GmbH, Schaffhausen (CH)

(72) Inventor: Jan Wikström, Sundbyberg (SE)

(21) Appl. No.: 19/136,430

(22) PCT Filed: Dec. 11, 2023
(86) PCT No.: PCT/EP2023/085084

§ 371 Date: Jun. 6, 2025

(30) Foreign Application Priority Data
Dec. 20, 2022 (EP) 22214788.6

(51) Int. Cl. F04D 29/22; F04D 1/06; F04D 13/08; F04D 29/02

(52) U.S. Cl. CPC F04D 29/2266; F04D 1/06; F04D 13/08; F04D 29/026; F04D 29/2211; F05D 2300/171; F05D 2300/226

(57) ABSTRACT

The invention relates to an impeller for a pump, the impeller including a hub, an upper cover disc connected to the hub, a lower cover disc and at least one vane extending between and connecting the upper cover disc and the lower cover disc, wherein the impeller includes a lower seal member that is located in a circumferential lower seat of the lower cover disc. The impeller is characterized in that the lower seat has an envelope surface, wherein the inner diameter of the lower seal member is greater than the diameter of the envelope surface of the lower seat, and that the impeller includes a retainer ring that is in press fit connection with the envelope surface of the lower seat, wherein the retainer ring is configured to retain the lower seal member in the lower seat. The invention also relates to a pump including such an impeller.

### CROSS-REFERENCE TO RELATED APPLICATIONS

This application is the United States national phase of International Patent Application No. PCT/EP2023/085084 filed Dec. 11, 2023, and claims priority to European Patent Application No. 22214788.6 filed Dec. 20, 2022, the disclosures of which are hereby incorporated by reference in their entireties.

### BACKGROUND OF THE INVENTION

### Field of the Invention

The present invention relates generally to the field of pumps configured to pump liquid comprising solid/abrasive matter. Further, the present invention relates specifically to the field of pumps such as sewage/wastewater pumps, dewatering pumps and drainage pumps especially configured for pumping liquid comprising solid matter, such as sand and stone material. The pumped liquid is for instance wastewater, drilling water in mining/tunneling applications, surface water on construction sites, etc. i.e. transport and dewatering applications. The present invention relates specifically to an impeller suitable for said pumps and applications, and relates also to a pump comprising such an impeller. The inventive pump may be wet installed and/or dry installed, and may be of submergible type in both installations.

The present invention relates to an impeller comprising a hub, an upper cover disc connected to the hub, a lower cover disc and at least one vane extending between and connecting the upper cover disc and the lower cover disc, wherein the impeller comprises a lower seal member that is located in a circumferential lower seat of the lower cover disc.

### Description of Related Art

In mines, tunneling, quarries, on construction sites, and the like applications, there is almost always a need to remove unwanted water in order to secure a dry enough environment at the working site. In mining/tunneling/quarries applications a lot of drilling water is used when preparing for charging before blasting, and water is also used to prevent dust spreading after the blasting, and if the production water is not removed at least the location of the blast and the lower parts of the mine will become flooded. Surface water and groundwater will also add up to accumulation of unwanted water to be removed. It is customary to use drainage/dewatering pumps to lift the water out of the mine to a settling basin located above ground, and the water is lifted stepwise from the lower parts of the mine to different basins/pits located at different depths of the mine. Each step/lift may for instance be in the range 25-50 meters in the vertical direction, and the length of the outlet conduit, i.e. the transport distance, in each step/lift may for instance be in the range 100-300 meters. In mining applications, a considerable amount of sand and stone material is suspended in the water, in some applications as much as 10%. Also pump stations for sewage/wastewater handle liquid comprising abrasive matter, especially pump stations also handling surface water. Thus, there are several applications wherein the pumped media is very abrasive and comprises sand, stones, etc. and applications wherein high head/pressure are required.

Between the stationary diffusor and the rotating impeller there are gaps at which a back flow of liquid will be generated from the downstream side to the upstream side due to pressure differences, i.e. generally speaking higher pressure on the downstream side of the impeller then on the upstream side of the impeller leading to a back flow in the upstream direction. Thereto, like the pumped media/liquid discharged from the pump also the back flow of liquid carries solid/abrasive matter/particles that are suspended in the media, and the abrasive particles will act as grinders on the surfaces of the gap, and the greater back flow the more wear on the gap and thereby greater back flow and decreased capacity/efficiency of the pump. Thus, back flow creates losses and the smaller gap the smaller back flow and thereby less wear and decreased losses over time.

However, a pump and especially a multistage pump having a plurality of pressure stages there are long tolerance chains in the construction. According to prior art, the location of the impeller side of the gap, i.e. the location of the impellers, are defined by the position of the drive shaft that is journalled in the housing of the drive unit, and the location of the stationary side of the gap, i.e. the location of the diffusers, are defined by the housing of the hydraulic unit that is connected to the housing of the drive unit. Thus, there are many components between the impeller side of the gap and the stationary side of the gap, i.e. a long tolerance chain, and in order to be able to have a small gap the tolerance range of each dimension/surface of each component has to be decreased/tight resulting in an accelerating increase of manufacturing/machining cost when having a long chain of tolerances.

A known way to try to provide small gaps is to have a lining of resilient material at the stationary parts, whereby some contact is allowed between the rotating part and the stationary part without entailing wear and risk for damages to the components. However, when/if the lining is lost there will be a huge decrease in capacity/efficiency of the multistage pump. The lining is not as resistive to wear as metal, and the abrasive matter will inevitably provide wear to the lining.

Generally, the site manager, i.e. the process at the working site, requires a constant low liquid level and therefor the drainage pump is in constant operation even though there is only little water/liquid available in the cavity/basins. The water can be constituted by ground water leakage, rainwater, and especially process water from drilling, reducing dust, etc. If the water is not removed the production will be negatively affected, which cannot be accepted. Thus, the water is pumped/transported by means of dewatering/drainage pumps. To be on the safe side, in many applications, the drainage pumps are in constant operation, irrespective of water being pumped or not. If the stationary parts and the rotating impeller comes in contact with each other at the gap when no media is pumped or present in the gap, the components are more susceptible for damage/wear. Due to the long tolerance chains and the risk of damage, the gaps of the prior art pumps are wider then optimal considered from a back flow point of view.

Thus, there is a need to be able to obtain smaller and/or more wear resistant gaps between the stationary parts and the rotating impellers of a pump without being forced to conduct labor-intensive and expensive manufacturing/machining of the components of the submergible multistage pump, and without being forced to harden exposed parts of the impeller.

When having tighter gaps between the rotating impeller and the stationary diffuser, it is a solution to use a face seal arrangement comprising a wear ring or seal member connected to the impeller, wherein the seal member is manufactured from a harder material than the impeller. According to prior art, the seal member is glued to the seat of the impeller in order to secure that the seal member does not disengage from the impeller. However, from a manufacturing/environmental point of view and from a workers health point of view there is a need to obtain a solution not comprising glue.

### SUMMARY OF THE INVENTION

The present invention aims at obviating the aforementioned disadvantages and failings of previously known impellers and pumps, and at providing an improved impeller and pump. A primary object of the present invention is to provide an improved impeller and pump of the initially defined type that comprises a construction that makes it possible to have small gaps between the stationary parts and the rotating impellers of the pump by having an impeller that is less susceptible to wear, and thereby less back flow and retained efficiency.

It is another object of the invention to provide an improved impeller and pump wherein the seal member is secured to the impeller without using glue. It is another object of the present invention to provide an improved impeller and pump that is more wear resistant due to decreased back flow at said gaps and thereby longer service interval may be applied. It is another object of the present invention to provide an improved impeller and pump that has less decrease in capacity/efficiency over time and thereby longer service interval may be applied. It is another object of the present invention to provide an improved impeller and pump that entails that fewer and smaller abrasive particles are passing through the gaps and thereby reduced wear from the back flow of pumped media and thereby longer service interval may be applied.

According to the invention at least the primary object is attained by means of the initially defined impeller and pump having the features defined in the independent claims. Preferred embodiments of the present invention are further defined in the dependent claims.

According to the present invention, the lower seat has an envelope surface, wherein the inner diameter of the lower seal member is greater than the diameter of the envelope surface of the lower seat, and that the impeller comprises a retainer ring that is in press fit connection with the envelope surface of the lower seat, wherein the retainer ring is configured to retain the lower seal member in the lower seat.

Thus, the present invention is based on the insight that when using of a lower seal member, that is less sensitive to wear, it is of outermost importance that the lower seal member is fixated to the impeller. Should the lower seal member become loose/break and disengage the impeller, the entire pump risk to become damaged.

Since the lower seal member is harder and more brittle than the impeller, the inventors has stipulated that the inner diameter of the lower seal member has to be greater than the diameter of the envelope surface of the lower seat. Should one try to have a press fit engagement between the lower seat and the lower seal member, the latter will crack/break upon mounting or when subject to already minor external force. Thus, the hard/brittle lower seal member is designed to manage wear but has less resistibility to tensile forces. It is no solution to manufacture the entire impeller of the same material as the lower seal member, since such impeller is much too expensive and also more prone to breakage. Thereto it is a wide aim within all manufacturing/mounting not to use glue/adhesive. Glue/adhesive is messy to handle, requires time to cure and requires safety measures for the work environment, which entails longer and more expensive mounting. Thus, the inventors have solved the necessity to securely fixate the lower seal member in the lower seat of the impeller without exerting the lower seal member for the risk of cracking/breaking and without the use of glue, by utilizing a retainer ring that is in press fit engagement with the lower seat, wherein the retainer ring is made of a material not prune to crack/break when exposed to tensile force. Thereby a harder and more wear resistant lower seal member may be utilized, resulting in a possibility to have a small gap and less wear, and thereby less back flow and longer service interval may be applied.

According to various embodiments of the present invention, a resilient member is located between and separates the lower seal member and the lower seat in the radial direction. Thereby the lower seal member is secured in a concentric relationship with the lower seat without the risk of having excessive tensile force acting on the lower seal member, at the same time as the resilient member will assist in securing corotation between the lower seal member and the impeller.

According to various embodiments of the present invention, the outer diameter of the retainer ring is smaller than the outer diameter of the lower seal member. Thereby the retainer ring will not risk to engage the seal member of the stationary part of the pump during operation.

According to various embodiments of the present invention, the impeller comprises an upper seal member connected to at least one of the hub and the upper cover disc of the impeller. By using an upper seal member at the upper interface between the impeller and the stationary part of the pump, any back flow at this interface can be suppressed at the same way as at the lower interface between the impeller and the stationary part of the pump, especially in a multistage pump.

Further advantages with and features of the invention will be apparent from the other dependent claims as well as from the following detailed description of preferred embodiments.

### BRIEF DESCRIPTION OF THE DRAWINGS

The terms Fig., Figs., Figure, and Figures are used interchangeably in the specification to refer to the corresponding figures in the drawings.

A more complete understanding of the abovementioned and other features and advantages of the present invention will be apparent from the following detailed description of preferred embodiments in conjunction with the appended drawings, wherein:

FIG. 1 is a schematic cross-sectional side view of an inventive pump comprising an inventive impeller,

FIG. 2 is a schematic cross-sectional side view of the hydraulic unit and part of the drive unit of a submergible multistage pump comprising a plurality of inventive impellers,

FIG. 3 is a schematic perspective view from above of an inventive impeller,

FIG. 4 is a schematic perspective view from below of the impeller according to FIG. 3, and

FIG. 5 is a schematic cross-sectional side view of the impeller according to FIGS. 3 and 4 together with the stationary part of the multistage pump.

### DESCRIPTION OF THE INVENTION

The present invention relates specifically to the field of submergible pumps especially configured for pumping liquid comprising abrasive/solid matter, such as water comprising sand and stone material. The submergible pumps are especially wastewater pumps and drainage/dewatering pumps. The present invention relates specifically to an impeller suitable for such pumps and such applications, and to a pump comprising such an impeller.

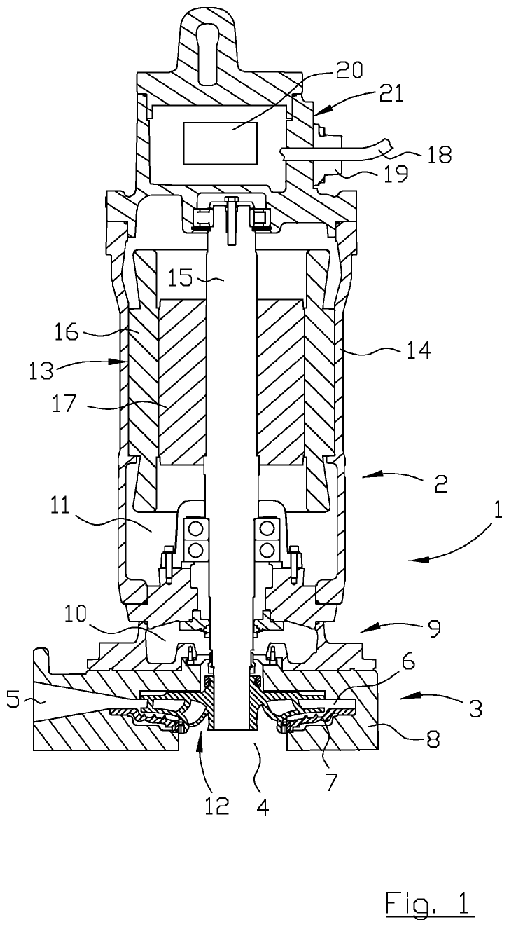

Reference is initially made to FIG. 1, disclosing a schematic illustration of cross-sectional side view of a pump, generally designated 1. The general structural elements of a pump 1 will be described with reference to FIG. 1. The pump 1 comprises two major parts, i.e. a drive unit, generally designated 2, and a hydraulic unit, generally designated 3.

The hydraulic unit 3 of the pump 1 comprises an inlet 4, an outlet 5 and a volute 6 located intermediate said inlet 4 and said outlet 5, i.e. the volute 6 is located downstream the inlet 4 and upstream the outlet 5. The volute 6 is partly delimited by an impeller seat, generally designated 7, that at least partly encloses the inlet 4 and by a housing 8. The impeller seat 7 is stationary and connected to the housing 8. The pump 1 also comprises an intermediate wall structure 9 separating the hydraulic unit 3 from the drive unit 2 of the pump 1 in a liquid tight manner. The intermediate wall structure 9 may also comprise a liquid seal chamber 10 or the like sealing arrangement between the volute 6 of the hydraulic unit 3 and a motor compartment 11 of the drive unit 2. Said volute 6 is also known as pump chamber and said impeller seat 7 is also known as suction cover, wear plate, inlet insert/plate, diffuser. In FIG. 1 the inlet 4 is an axial inlet and the outlet 5 is a radial outlet.

In some applications, the outlet 5 of the hydraulic unit 3 also constitutes the outlet of the pump 1 (as disclosed in FIG. 1) and in other applications the outlet 5 of the hydraulic unit 3 is connected to a separate outlet of the pump 1, e.g. via a cooling jacket volume. The outlet of the pump 1 is configured to be connected to an outlet conduit (not shown). Thereto the pump 1 comprises an impeller, generally designated 12, wherein the impeller 12 is located in the volute 6, i.e. the hydraulic unit 3 of the pump 1 comprises an impeller 12. The impeller 12 is a channel impeller having so-called closed channels.

The hydraulic unit 3 of the pump may comprise an inlet strainer having perforations or holes, wherein the inlet strainer is configured to prevent larger objects from reaching the inlet 4 and the volute 6. Such larger objects may otherwise jam or clog the impeller 12.

The drive unit 2 of the pump 1 comprises an electric motor, generally designated 13, arranged in a liquid tight pump housing 14, and a drive shaft 15 extending from the electric motor 13 through the intermediate wall structure 9 and into the volute 6. The electric motor 13 comprises a stator 16 and a rotor 17, wherein the drive shaft 15 is connected to the rotor 17 of the electric motor 13 in conventional way. The impeller 12 is connected to and driven in rotation by the drive shaft 15 during operation of the pump 1, wherein liquid is sucked into said inlet 4 and pumped out through said outlet 5 by means of the rotating impeller 12 when the pump 1 is active. The pump housing 14, the housing 8, the impeller seat 7, the impeller 12, and other essential components, are preferably made of metal, such as aluminum and steel. The electric motor 13 is powered via an electric power cable 18 extending from a power supply, and the pump 1 comprises a liquid tight lead-through 19 receiving the electric power cable 18.

According to various embodiments, the pump 1, more precisely the electric motor 13, is operatively connected to a control unit 20, such as an Intelligent Drive comprising a Variable Frequency Drive (VFD). Thus, said pump 1 is configured to be operated at a variable operational speed [rpm], by means of said control unit 20. According to various embodiments, the control unit is located inside the liquid tight pump housing 14, e.g. in an electronics chamber of a top unit 21, i.e. it is preferred that the control unit 20 is integrated into the pump 1. The top unit 21, i.e. the electronics/connection chamber, is separated from the motor compartment 11 in a liquid tight manner. The control unit 20 is configured to control the operational speed of the pump 1. According to alternative embodiments the control unit is an external control unit, or the control unit is divided into an external sub-unit and an internal sub-unit. The operational speed of the pump 1 is more precisely the rpm of the electric motor 13 and of the impeller 12 and correspond/relate to a control unit output frequency. The control unit 20 is configured and capable of operating the pump 1 and impeller 12 in a normal direction of rotation, i.e. forward, in order to pump liquid, and in an opposite direction of rotation, i.e. backwards, in order to clean or unblock the volute 6 and impeller 12.

The components of the pump 1 are usually cold down by means of the liquid/water surrounding the pump 1, i.e. when the pump 1 is in a submerged configuration/application. In dry installed applications/configurations the pump 1 comprises dedicated cooling systems. Both configurations may comprise a submergible pump 1, i.e. the pump 1 is designed and configured to be able to operate in a submerged configuration/position, i.e. during operation be located entirely under the liquid surface. However, it shall be realized that the submersible pump 1 during operation must not be entirely located under the liquid surface but may continuously or occasionally be fully or partly located above the liquid surface.

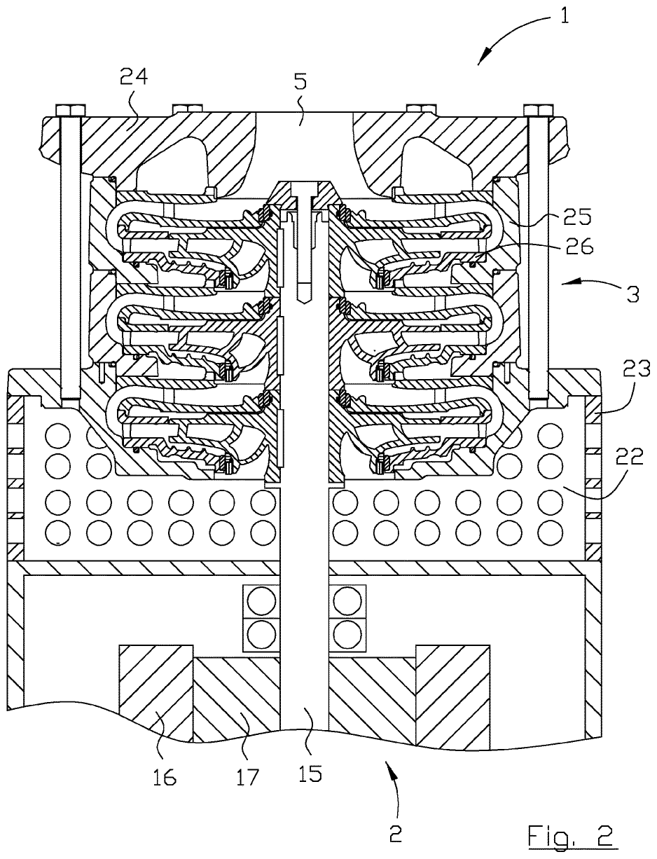

Reference is now made to FIG. 2, disclosing a hydraulic unit 3 of a multistage pump 1 and portions of the drive unit 2, wherein elements/components of the FIG. 2 embodiment/pump corresponding to elements/components of the FIG. 1 embodiment/pump are given the same reference numbers. One difference is that according to FIG. 2, the drive unit 2 is located separated from the hydraulic unit 3 by an inlet volume 22, wherein the drive shaft 15 extends from the rotor 17 of the drive unit 2 through the inlet volume 22 to the hydraulic unit 3. The inlet volume 22 is delimited by an inlet strainer 23. According to the FIG. 2 embodiment the drive unit 2 is located on the upstream side of the inlet 4 of the hydraulic unit 3. The inlet strainer 23 comprises perforations or holes, wherein the inlet strainer 23 is configured to prevent larger objects from reaching the inlet 4 of the leading pressure stage.

A multistage pump comprises a plurality of pressure stages connected in series with each other, wherein the disclosed embodiment comprises three pressure stages. The hydraulic unit 3 also comprises a top element 24 comprising the outlet 5 of the hydraulic unit 3 and of the pump 1. Each pressure stage comprises an impeller 12 connected to the drive shaft 15, wherein the impeller 12 is driven in rotation during operation of the pump 1. Each pressure stage also comprises a circumferential housing 25 and a circumferential internal diffuser 26, wherein the housing 25, the diffuser 26 and the impeller 12 define a flow path from the inlet to the outlet of the pressure stage. The diffuser 26 is connected to the housing 25, wherein the diffuser 26 and the housing 25 are stationary. The outlet of one pressure stage is connected to the inlet of the next pressure stage, seen in the downstream direction. According to the disclosed embodiment all inlets of the pressure stages are configured as axial inlets and all outlets of the pressure stages are configured as axial outlets. The outlet 5 of the pump 1 is configured as an axial outlet in the disclosed embodiment, but it shall be realized that the outlet 5 may be configured as a radial outlet.

The present invention is based on a new and improved impeller 12, that is configured to be used in pumps 1 pumping abrasive media, for instance water or wastewater/sewage comprising sand and stones.

Between the stationary diffusor 26 and the rotating impeller 12 there are gaps at which a back flow of liquid will be generated from the downstream side to the upstream side due to pressure differences, i.e. generally speaking higher pressure on the downstream side of the impeller 12 then on the upstream side of the impeller 12 leading to a back flow in the upstream direction. Thereto, like the pumped media/liquid discharged from the pump 1 also the back flow carries solid/abrasive matter/particles that are suspended in the media, and the abrasive particles will act as grinders on the surfaces of the gap, and the greater back flow the more wear on the gap and thereby greater back flow and decreased capacity/efficiency of the pump. Impellers 12 wear quite fast in such installations due to the solid/abrasive matter in the pumped liquid and conventionally need to be replaced every 7 weeks in rough conditions because of accelerating decrease in efficiency of the pump 1 when the impeller 12 wear.

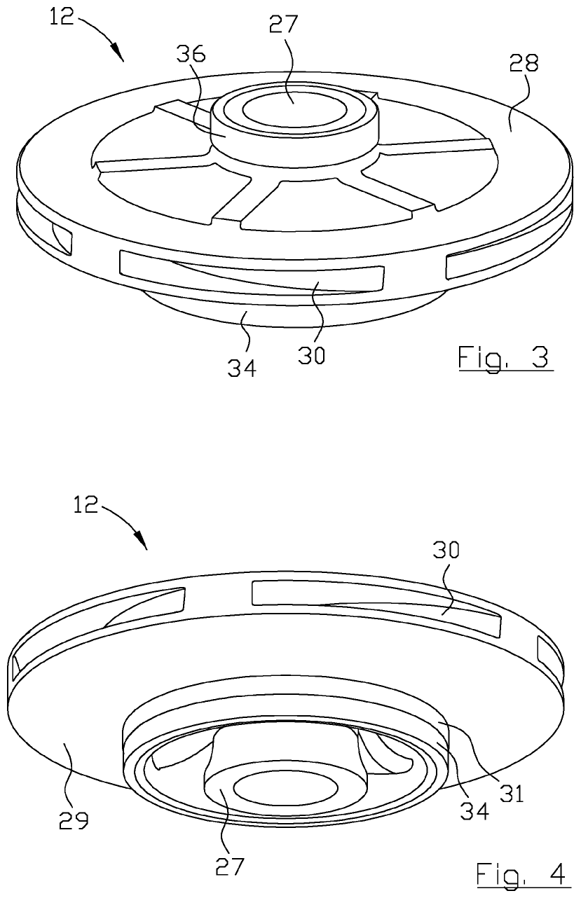

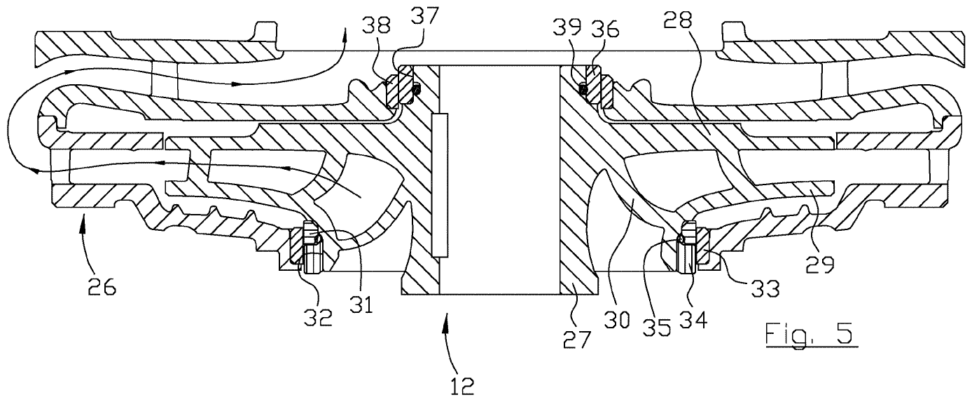

Reference is now made to FIGS. 3-5 disclosing an inventive impeller 12, that is a closed channel impeller. The impeller 12 comprises a hub 27, an upper cover disc/plate 28 connected to the centrally located hub 27, a lower cover disc/plate 29 and at least one vane 30 extending between and connecting the upper cover disc 28 and the lower cover disc 29. The impeller 12 preferably comprises a plurality of vanes/blades 30 that are equidistantly located around the hub 27. The vane/vanes 30 are preferably spirally swept from an inner leading edge to an outer trailing edge, i.e. in the direction from the hub 27 towards the periphery of the impeller 12, in a direction opposite the direction of rotation of the impeller 12 during normal (liquid pumping) operation of the pump 1.

Each blade 30 comprises a leading edge adjacent the hub 27 and a trailing edge at the periphery of the impeller 12, wherein two adjacent blades 30 together defines a channel extending from the leading edges to the trailing edges. The leading edge is located adjacent the inlet 4. During operation, the leading edges grabs hold of the liquid, the channels accelerate the liquid and the liquid leaves the impeller 12 at the trailing edges. Thereafter the liquid is guided by the diffusers 26 and housing 25 (or volute 6) towards the outlet. Thus, the liquid is sucked into the impeller 12 and pressed out of the impeller 12. Said channels are also delimited by the upper cover plate 28 and the lower cover plate 29 of the impeller 12. The diameter of the impeller 12 and the shape and configuration of the channels/vanes determines the pressure build up in the liquid and the pumped flow.

According to the invention, the impeller 12 comprises a lower seal member 31 that is located in a circumferential lower seat 32 of the lower cover disc 29, wherein the lower seat 32 has an envelope surface. The lower seal member 31 of the impeller 12 is configured to co-rotate with the impeller 12.

The lower seal member 31 of the impeller 12 is configured to cooperated with a lower seal member 33 of the diffuser 26, wherein the lower seal member 33 of the diffuser 26 is stationary. Thus, the lower seal member 31 of the impeller 12 and the lower seal member 33 of the diffuser 26 together constitute a lower face seal having an axially extending gap between an outer diameter of the lower seal member 31 of the impeller 12 and an inner diameter of the lower seal member 33 of the diffuser 26. The lower seal member 33 of the diffuser 26 is preferably in press fit engagement with the diffuser 26, in order to avoid use of glue/adhesive. The lower seal member/ring 33 of the diffuser 26 is subject to compressive force/strain. Hereinbelow the wear plate 7 shall be considered full equivalent to the diffusor 26, i.e. the lower seal member 31 of the impeller 12 may also cooperate with a lower seal member 33 of the wear plate 7 in the same way.

The lower seal member 31 of the impeller 12 and the lower seal member 33 of the diffuser 26 are made of material that is less affected by wear than the impeller 12 and the diffuser 26. The lower seal member 31 of the impeller 12 and the lower seal member 33 of the diffuser 26 preferably comprises or is made of cemented carbide or the like.

The inventor has identified that the lower seal member 31 of the impeller 12 shall not be exposed to elevated tensile force, due to the risk of breaking/bursting during mounting and during operation, and thereby must not be in press fit engagement with the lower seat 32 of the lower cover disc 29. Thus, the inner diameter of the lower seal member 31 of the impeller 12 is greater than the diameter of the envelope surface of the lower seat 32 of the impeller 12. In order to secure that the lower seal member 31 co-rotate with the impeller 12, the impeller 12 comprises a retainer ring 34 that is in press fit connection with the envelope surface of the lower seat 32 of the impeller 12, wherein the retainer ring 34 is configured to retain/clamp the lower seal member 31 in the lower seat 32 of the lower cover disc 29. The retainer ring 34 is made of material that is able to withstand greater tensile forces than the lower seal member 31. The retainer ring 34 is preferably made of duplex stainless steel or the like. According to various embodiments there is mechanical engagement, i.e. pin or the like, between the retainer ring 34 and the lower seal member 31 in order to secure co-rotation of the lower seal member 31 and the impeller 12.

According to various embodiments, the outer diameter of the retainer ring 34 is smaller than the outer diameter of the lower seal member 31. Thereby, it is easier to mount/insert the impeller 12 into the lower seal member 33 of the diffuser 26, thanks to the smaller outer diameter of the retainer ring 34. Thereto the envelope surface of the lower seat 32 of the lower cover disc 29 may have different diameters for the lower seal member 31 and the retainer ring 34.

According to various embodiments, a resilient member 35 is located between and separates the lower seal member 31 and the lower seat 32 in the radial direction. The resilient member 35 is preferably constituted by a rubber O-ring. Thereby the lower seal member 31 is centred in relation to the lower seat 32 and thereby in relation to the drive shaft 15. According to various embodiments, the retainer ring 34 abuts the resilient member 35, and the lower seal member 31. Thus, the retainer ring 34 clamps the lower seal member 31 in the axial direction in order to have the lower seal member 31 co-rotate with the impeller 12. The resilient member 35 also promotes co-rotation of the lower seal member 31 and the impeller 12. Thereto, the resilient member 35 works as a damper, i.e. entailing that the lower seal member 31 may be slightly displaced in the radial direction should it be exposed to external force in the radial direction, i.e. due to contact between the lower seal member 31 of the impeller 12 and the lower seal member 33 of the diffusor 26.

According to various embodiments, the impeller 12 also comprises an upper seal member 36 connected to at least one of the hub 27 and the upper cover disc 28 of the impeller 12. The upper seal member 36 is located in a circumferential upper seat 37 having an envelope surface. The upper seal member 36 of the impeller 12 is configured to co-rotate with the impeller 12.

The upper seal member 36 of the impeller 12 is configured to cooperated with an upper seal member 38 of the diffuser 26, wherein the upper seal member 38 of the diffuser 26 is stationary. Thus, the upper seal member 36 of the impeller 12 and the upper seal member 38 of the diffuser 26 together constitute an upper face seal having an axially extending gap between an outer diameter of the upper seal member 36 of the impeller 12 and an inner diameter of the upper seal member 38 of the diffuser 26. The upper seal member 38 of the diffuser 26 is preferably in press fit engagement with the diffuser 26, in order to avoid use of glue/adhesive. The upper seal member/ring 38 of the diffuser 26 is subject to compressive force/strain.

The upper seal member 36 of the impeller 12 and the upper seal member 38 of the diffuser 26 are made of material that is less affected by wear than the impeller 12 and the diffuser 26. The upper seal member 36 of the impeller 12 and the upper seal member 38 of the diffuser 26 preferably comprises or is made of cemented carbide or the like.

The inventor has identified that the upper seal member 36 of the impeller 12 shall not be exposed to elevated tensile force, due to the risk of breaking/bursting, and thereby must not be in press fit engagement with the upper seat 37 of the impeller 12. Thus, the inner diameter of the upper seal member 36 is larger than the diameter of the envelope surface of the upper seat 37.

In order to promote co-rotation of the upper seal member 36 with the impeller 12 and in order to prevent back-flow, the impeller 12 according to various embodiments comprises a resilient member 39 that is located between and separates the upper seal member 36 and the upper seat 37 in the radial direction. The resilient member 39 between the upper seal member 36 and the upper seat 37 is preferably constituted by a rubber O-ring. Thereto, the resilient member 39 works as a damper, i.e. entailing that the upper seal member 36 may be slightly displaced in the radial direction should it be exposed to external force in the radial direction, i.e. due to contact between the upper seal member 36 of the impeller 12 and the upper seal member 38 of the diffusor 26.

According to various embodiments, the outer diameter of the lower seal member 31 of the impeller 12 is greater than the outer diameter of the upper seal member 36 of the impeller 12. Thereto, the radial gap width of the upper face seal is equal to or less than the radial gap width of the lower face seal, thereby in case of drive shaft 15 deflection the upper face seal will contact before the lower face seal which is preferred since the mutual surface velocity is lower at the upper face seal than at the lower face seal. According to various embodiments, the radial gap width of the upper face seal is equal to or more than 0.05 mm and equal to or less than 0.25 mm, preferably 0.15 mm, and the radial gap width of the lower face seal is equal to or more than 0.1 mm and equal to or less than 0.3 mm, preferably 0.2 mm.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and thus, the equipment may be modified in all kinds of ways within the scope of the appended claims.

It shall also be pointed out that all information about/concerning terms such as above, under, upper, lower, etc., shall be interpreted/read having the equipment oriented according to the figures, having the drawings oriented such that the references can be properly read. Thus, such terms only indicate mutual relations in the shown embodiments, which relations may be changed if the inventive equipment is provided with another structure/design.

It shall also be pointed out that even thus it is not explicitly stated that features from a specific embodiment may be combined with features from another embodiment, the combination shall be considered obvious, if the combination is possible.

1. An impeller for a pump, the impeller comprising a hub, an upper cover disc connected to the hub, a lower cover disc and at least one vane extending between and connecting the upper cover disc and the lower cover disc, wherein the impeller comprises a lower seal member that is located in a circumferential lower seat of the lower cover disc,
wherein the lower seat has an envelope surface, wherein the inner diameter of the lower seal member is greater than the diameter of the envelope surface of the lower seat, and that the impeller comprises a retainer ring that is in press fit connection with the envelope surface of the lower seat, wherein the retainer ring is configured to retain the lower seal member in the lower seat.

2. The impeller according to claim 1, wherein a resilient member is located between and separates the lower seal member and the lower seat in the radial direction.

3. The impeller according to claim 2, wherein the resilient member is constituted by a rubber O-ring.

4. The impeller according to claim 2, wherein the retainer ring abuts the resilient member, and the lower seal member.

5. The impeller according to claim 1, wherein the outer diameter of the retainer ring is smaller than the outer diameter of the lower seal member .

6. The impeller according to claim 1, wherein the impeller comprises an upper seal member connected to at least one of the hub and the upper cover disc of the impeller.

7. The impeller according to claim 6, wherein the upper seal member is located in a circumferential upper seat having an envelope surface, wherein the inner diameter of the upper seal member is larger than the diameter of the envelope surface of the upper seat.

8. The impeller according to claim 7, wherein a resilient member is located between and separates the upper seal member and the upper seat in the radial direction.

9. The impeller according to claim 8, wherein the resilient member is constituted by a rubber O-ring.

10. The impeller according to claim 1, wherein the lower seal member comprises cemented carbide.

11. The impeller according to claim 1, wherein the retainer ring is made of duplex stainless steel.

12. A pump configured for pumping liquid comprising abrasive matter, the pump comprising a drive unit having an electric motor and a drive shaft, and a hydraulic unit having an inlet and an outlet and at least one impeller connected to the drive shaft of the drive unit, wherein the at least one impeller is constituted by an impeller according to claim 1.

13. The pump according to claim 12, wherein the pump is constituted by a submergible multistage pump having a plurality of pressure stages, wherein each pressure stage comprises an impeller, wherein the impeller has a lower seat and a lower seal, the lower seat on the impeller has an envelope surface, wherein an inner diameter of the lower seal member is greater than a diameter of the envelope surface of the lower seat, and that the impeller comprises a retainer ring that is in press fit connection with the envelope surface of the lower seat, wherein the retainer ring is configured to retain the lower seal member in the lower seat.
